(19) United States
(12) Patent Application Publication
(10) Pub. No.: US 2022/0193554 A1
(43) Pub. Date: Jun. 23, 2022

(54) DEVICE AND METHOD FOR GENERATING NPC CAPABLE OF ADJUSTING SKILL LEVEL

(71) Applicant: Electronics and Telecommunications Research Institute, Daejeon (KR)

(72) Inventors: Dae Wook KIM, Daejeon (KR); Sung Yun PARK, Daejeon (KR); Seong Il YANG, Daejeon (KR)

(21) Appl. No.: 17/554,597

(22) Filed: Dec. 17, 2021

(30) Foreign Application Priority Data
Dec. 17, 2020 (KR) 10-2020-0177067

(51) Int. Cl. A63F 13/67; A63F 13/798

(52) U.S. Cl. CPC A63F 13/67; A63F 2300/6027; A63F 13/798

(57) ABSTRACT

A device for generating a non-player character (NPC) capable of adjusting a skill level is provided. The device includes an NPC generator configured to generate an NPC having a skill level value adjusted based on a certain skill level adjustment parameter for each skill level factor, an NPC pool storage configured to store the generated NPC, and an NPC extractor configured to extract an NPC, corresponding to a skill level value input by a user, in the NPC pool storage and to provide the extracted NPC to content.

### CROSS-REFERENCE TO RELATED APPLICATIONS

This application claims priority under 35 U.S.C. § 119 to Korean Patent Application No. 10-2020-0177067, filed on Dec. 17, 2020, the disclosure of which is incorporated herein by reference in its entirety.

### TECHNICAL FIELD

The present invention relates to a device and method of generating a non-player character (NPC) capable of adjusting a skill level.

### BACKGROUND

Recently, as Internet infrastructure advances rapidly for several years, online games evolve in various forms. In this case, information needed for executing games are generally obtained by an interaction such as a conversation with an in-game non-player character (NPC).

With the advancement of artificial intelligence (AI), NPCs may obtain a strategy for playing a game best in an assigned game environment through self-learning. As an example where such technology is applied, there is “Human-level control through deep reinforcement learning”, “Mastering the game of Go with deep neural networks and tree search”, “Grandmaster level in StarCraft II using multi-agent reinforcement learning”, and a technology skill level is high so that the technology skill level is higher than levels of most persons.

However, an NPC generated based on the related art is higher in learning level than a user, and due to this, there are many cases where game users do not feel an interest when commercial content is actually applied. That is, NPCs should be generated and learned to have a level of difficulty similar to game users, and although the game users have a similar level of difficulty, the NPCs should have various skill levels in detail and should enable the game users to directly select a skill level suitable for the game users.

Moreover, games try to change little by little by correcting a game internal environment parameter through patch so that users feel an interest continuously. However, because the related art is set so that NPCs play a game best, there is a problem where users is difficult to adapt to a change in NPCs.

### SUMMARY

Accordingly, the present invention provides a device and method of generating an NPC capable of adjusting a skill level, which adjust a detailed skill level in real time to generate and provide an NPC in content.

The objects of the present invention are not limited to the aforesaid, but other objects not described herein will be clearly understood by those skilled in the art from descriptions below.

In one general aspect, a device for generating a non-player character (NPC) capable of adjusting a skill level includes: an NPC generator configured to generate an NPC having a skill level value adjusted based on a certain skill level adjustment parameter for each skill level factor; an NPC pool storage configured to store the generated NPC; and an NPC extractor configured to extract an NPC, corresponding to a skill level value input by a user, in the NPC pool storage and to provide the extracted NPC to content.

In another general aspect, a device for generating a non-player character (NPC) capable of adjusting a skill level includes: a communication module configured to receive a skill level value input from a user and to provide the user with a non-player character (NPC) corresponding to the received skill level value; a memory including a program for adjusting a skill level value of an NPC on the basis of a certain skill level adjustment parameter for each skill level factor and an NPC pool storage configured to store NPCs; and a processor configured to execute the program stored in the memory, wherein, by executing the program, the processor generates an NPC having a skill level value adjusted based on a certain skill level adjustment parameter for each skill level factor, extracts an NPC, corresponding to the input skill level value, in the NPC pool storage, and provides the extracted NPC to content.

In another general aspect, a method of generating a non-player character (NPC) capable of adjusting a skill level is performed by a computer and includes: generating an NPC having a skill level value adjusted based on a certain skill level adjustment parameter for each skill level factor; storing the generated NPC in an NPC pool storage; receiving a skill level value input from a user; extracting an NPC, corresponding to the received skill level value, in the NPC pool storage; and providing the extracted NPC to content.

A computer program according to another embodiment of the present invention for solving the above-described problem may be coupled to a computer which is hardware, may execute an NPC generating method capable of adjusting skill level, and may be stored in a computer-readable recording medium.

Other features and aspects will be apparent from the following detailed description, the drawings, and the claims.

### BRIEF DESCRIPTION OF THE DRAWINGS

FIG. 1 is a block diagram of a device for generating an NPC according to an embodiment of the present invention.

FIG. 2 is a diagram for describing an NPC generator.

FIG. 3 is a diagram for describing an environment adaptation unit.

FIG. 4 is a diagram for describing an NPC extractor.

FIG. 5A and FIG. 5B are diagram for describing an operation of extracting an NPC on the basis of a skill level adjustment parameter.

FIG. 6 is a block diagram of a device for generating an NPC according to another embodiment of the present invention.

FIG. 7 is a flowchart of a method of generating an NPC capable of adjusting skill level according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Hereinafter, embodiments of the present invention will be described in detail with reference to the accompanying drawings. It will be understood that although the terms including an ordinary number such as first or second are used herein to describe various elements, these elements should not be limited by these terms. These terms are only used to distinguish one element from another element. For example, a first element may be referred to as a second element without departing from the spirit and scope of the present invention, and similarly, the second element may also be referred to as the first element.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

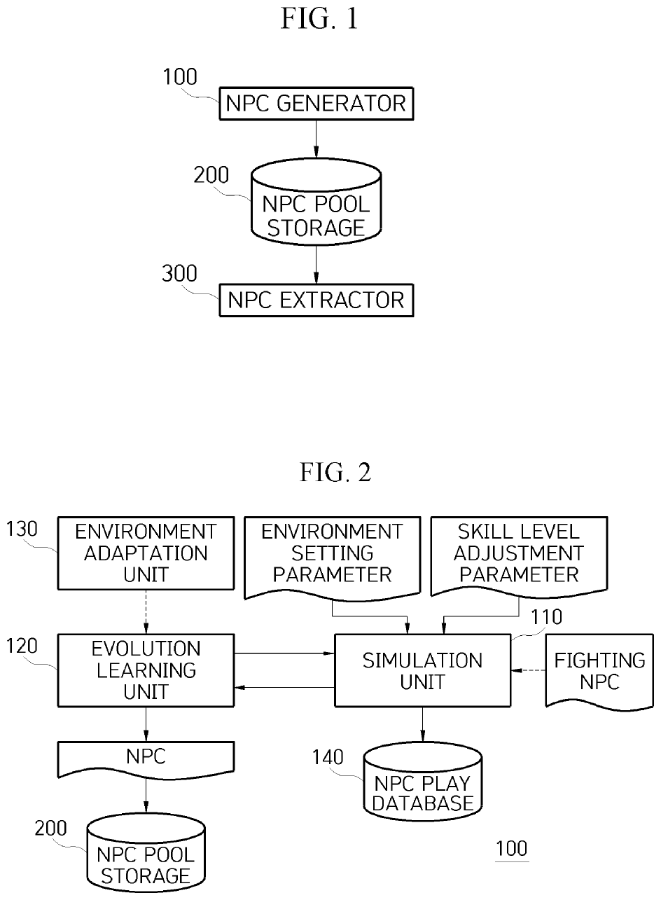

Hereinafter, a device for generating an NPC capable of adjusting a skill level (hereinafter referred to as an NPC generating device) 1 according to an embodiment of the present invention will be described with reference to FIGS. 1 to 5.

FIG. 1 is a block diagram of an NPC generating device 1 according to an embodiment of the present invention.

The NPC generating device 1 according to an embodiment of the present invention may include an NPC generator 100, an NPC pool storage 200, and an NPC extractor 300.

The NPC generator 100 may generate an NPC having a skill level value adjusted based on a certain skill level adjustment parameter for each skill level factor.

The NPC pool storage 200 may store an NPC generated by the NPC generator 100.

The NPC extractor 300 may extract an NPC, corresponding to a skill level value input by a user, in the NPC pool storage 200. Also, the extracted NPC may be provided to content.

A skill level of an NPC defined in an embodiment of the present invention may be a concept which differs from a level of difficulty and a style. A level of difficulty may denote that relative achievement capability for achieving the purpose of content such as a game is quantitatively evaluated on a player character (PC) or an NPC. Also, a style may denote that various methods for achieving the purpose of content like strategy and tactic are classified into groups each including similar methods.

On the other hand, a skill level may denote factors of a lower level affecting a level of difficulty and a style. Based on a combination of skill levels, levels of difficulty and styles may be classified and determined.

Such skill levels may be divided for each of a plurality of skill level factors needed for content, and a skill level value of each of the skill level factors may be adjusted based on a skill level adjustment parameter.

In an embodiment, the skill level adjustment parameter may include a first skill level adjustment parameter, which is a skill level corresponding to a physical factor of a user, and a second skill level adjustment parameter which corresponds to a content play capability of the user.

For example, a physical factor corresponding to the first skill level adjustment parameter may include a reaction speed, a hand speed, and multitasking capability, and content play capability corresponding to the second skill level adjustment parameter may include strategy implementation capability, situation determination capability, situation analysis capability, other party action prediction capability, and a concentration level based on a game time.

FIG. 2 is a diagram for describing the NPC generator 100.

The NPC generator 100 may include a simulation unit 110, an evolution learning unit 120, and an environment adaptation unit 130.

The simulation unit 110 may set environment information about content from various parameters and may perform simulation so that learning of an NPC is performed based on the set content environment information.

In detail, the simulation unit 110 may receive the skill level adjustment parameter for adjusting a skill level value of the NPC to set content environment information. In this case, the simulation unit 110 may receive the skill level adjustment parameter and an environment setting parameter for directly setting the content environment information to set the content environment information.

Here, the environment setting parameter may include various parameter information affecting an environment of content, and for example, may include a physical strength, a job, a skill, a configuration, and a skill cool time of the NPC, a physical strength of a monster, a skill of the monster, and an offence force of the monster.

The skill level adjustment parameter, as described above, may include various parameter information for adjusting a skill level of the NPC, and like being classified into a physical factor and a mental factor, the skill level adjustment parameter may include a reaction speed, a hand speed, multitasking capability, strategy implementation capability, and situation determination capability.

As the content environment information is set, the simulation unit 110 may generate a result state of a simulated NPC on the basis of the set content environment information and may provide the generated result state of the NPC to the evolution learning unit 120.

Moreover, the simulation unit 110 may receive the NPC generated by the evolution learning unit 120, simulate an action of the NPC, and provide a result state of the simulated NPC to the evolution learning unit 120. That is, the simulation unit 110 may cooperate with the evolution learning unit 120 and may learn and generate the NPC.

In an embodiment, the simulation unit 110 may be provided with a ready fighting NPC depending on the case and may perform simulation. That is, the simulation unit 110 may receive at least one fighting NPC among an NPC which plays based on a rule, a self-replicated NPC, and an NPC based on a finite state machine (FSM) and may perform simulation.

Subsequently, the evolution learning unit 120 may generate an NPC through an interaction with the simulation unit 110, generate an NPC on the basis of a result state of an NPC simulated by the simulation unit 110, and store the NPC in the NPC pool storage 200.

The evolution learning unit 120 may include a certain algorithm for generating an NPC. For example, the evolution learning unit 120 may apply various algorithms such as a reinforcement learning-based algorithm, a rule defined by a user, a search algorithm, and a genetic algorithm to generate an NPC. An NPC may be expressed by one of the various algorithms or a combination of a plurality of output values.

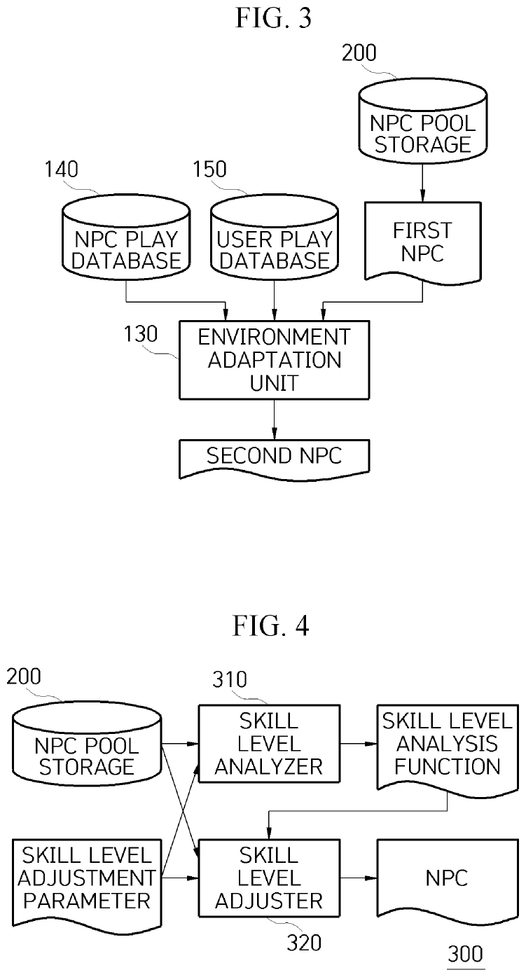

FIG. 3 is a diagram for describing the environment adaptation unit 130.

In an embodiment of the present invention, the environment adaptation unit 130 may provide the evolution learning unit 120 with an NPC which is previously learned to a degree.

In an embodiment, the environment adaptation unit 130 may receive NPC play data, play data of a user, and a first NPC which is previously learned and stored in the NPC pool storage 200 and may combine the NPC play data, the play data, and the first NPC, adapt the NPC play data, the play data, and the first NPC to a changed environment, or perform a learning process based on a certain learning algorithm for modification, thereby generating a second NPC.

Here, the first NPC may denote an object which is adapted to an environment on the basis of the NPC stored in the NPC pool storage 200 and is to be additionally modified, and the second NPC may denote an NPC modified through the environment adaptation unit 130.

In this case, the environment adaptation unit 130 may use a learning algorithm such as distillation or reinforcement learning using a replay memory.

In an embodiment, the NPC generator 100 may further include an NPC play database 140. The NPC play database 140 may collect NPC play data which is generated in a simulation process performed by the simulation unit 110. For example, the NPC play data may be constructed in a record form and may include at least one of an environment setting parameter, a skill level adjustment parameter, current and next state information about an NPC, action information about the NPC, and compensation information about the NPC.

The play data of the user stored in the user play database 150 may denote data which has been played by the user in content and may be stored in a form similar to the NPC play data.

The second NPC generated as described above may be provided to the evolution learning unit 120, or may be again stored in the NPC pool storage 200.

FIG. 4 is a diagram for describing the NPC extractor 300.

In an embodiment of the present invention, the NPC extractor 300 may extract an NPC from the NPC pool storage 200 and may provide the extracted NPC and may include a skill level analyzer 310 and a skill level adjuster 320.

The skill level analyzer 310 may analyze a correlation between the skill level adjustment parameter and the NPC stored in the NPC pool storage 200 and may generate a skill level analysis function on the basis of the correlation. For example, the skill level analyzer 310 may generate the skill level analysis function by using Pearson correlation coefficient (PCC), regression analysis, a neural network, and/or the like. Such a skill level analysis function may be expressed as an approximate model such as a neural network or a formula.

Subsequently, the skill level adjuster 320 may extract an NPC, corresponding to a skill level value input by the user, in the NPC pool storage 200 on the basis of the skill level analysis function and may provide the extracted NPC to content.

The generated NPC may be one of NPCs stored in the NPC pool storage 200. That is, the skill level adjuster 320 may extract an NPC, which is within the same or similar range having a skill level value input by the user and a skill level value within a predetermined range, in the NPC pool storage 200.

Alternatively, when there is no NPC accurately corresponding to a condition, the skill level adjuster 320 may generate an NPC where result values of several NPCs are combined by the skill level analysis function and may provide the generated NPC. That is, when an NPC having a skill level value input by the user and a skill level value within a predetermined range is not stored in the skill level adjuster 320, the skill level adjuster 320 may combine a plurality of NPCs on the basis of the skill level analysis function to generate and provide an NPC having the skill level value within the predetermined range.

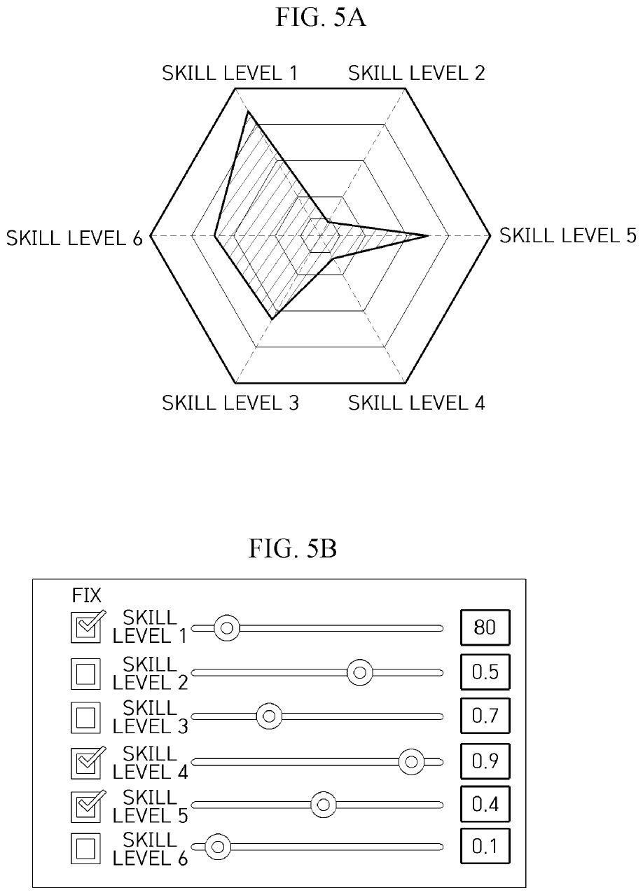

FIG. 5A and FIG. 5B are diagram for describing an operation of extracting an NPC on the basis of a skill level adjustment parameter.

For example, when there are a total of skill level factors corresponding to content, a user may adjust each skill level value corresponding to the skill level factor.

Moreover, when the user performs an input of fixing at least one skill level value of a plurality of skill level factors, the skill level adjuster 320 may determine a skill level value corresponding to the other skill level factor on the basis of the skill level analysis function.

Moreover, the skill level factors may depend on one another on the basis of the skill level analysis function where a correlation has been analyzed, and thus, some skill level factors may each have a skill level value which is determined based on one or more other skill values.

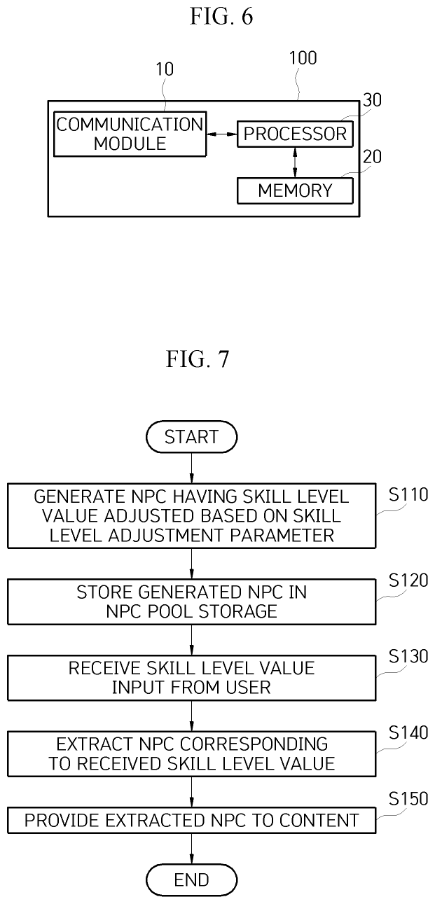

FIG. 6 is a block diagram of an NPC generating device 1 according to another embodiment of the present invention.

The NPC generating device 1 according to another embodiment of the present invention may include a communication module 10, a memory 20, and a processor 30.

The communication module 10 may receive a skill level value input from a user and may provide the user with an NPC corresponding to the input skill level value.

The memory 20 may store a program for adjusting a skill level value of an NPC on the basis of a certain skill level adjustment parameter for each skill level factor and an NPC pool storage 200 which stores NPCs.

By executing the program stored in the memory 20, the processor 30 may generate an NPC having a skill level value adjusted based on a certain skill level adjustment parameter for each skill level factor, extract an NPC, corresponding to the input skill level value, in the NPC pool storage 200, and provide the extracted NPC to content.

Hereinafter, a method of generating an NPC capable of adjusting skill level according to an embodiment of the present invention will be described with reference to FIG. 7.

FIG. 7 is a flowchart of a method of generating an NPC capable of adjusting skill level according to an embodiment of the present invention.

Moreover, it may be understood that each step illustrated in FIG. 7 is performed by the NPC generating device 1 described above, but the present embodiment is not limited thereto.

First, an NPC having a skill level value adjusted based on a certain skill level adjustment parameter for each skill level factor may be generated in step S110, and the generated NPC may be stored in the NPC pool storage 200 in step S120.

Subsequently, when a skill level value input from a user is received in step S130, an NPC corresponding to the received skill level value may be extracted in the NPC pool storage 200 in step S140.

Subsequently, the extracted NPC may be provided to content in step S150.

In the above description, steps S110 to S150 may be further divided into additional steps, or may be combined into fewer steps. Also, depending on the case, some steps may be omitted, and the order of steps may be changed. Despite other omitted descriptions, descriptions given with reference to FIGS. 1 and 6 may be applied to the NPC generating method of FIG. 7.

An embodiment of the present invention described above may be implemented as a program (or an application) and may be stored in a medium, so as to be executed in connection with a server which is hardware.

The above-described program may include a code encoded as a computer language such as C, C++, JAVA, or machine language readable by a processor (CPU) of a computer through a device interface of the computer, so that the computer reads the program and executes the methods implemented as the program. Such a code may include a functional code associated with a function defining functions needed for executing the methods, and moreover, may include an execution procedure-related control code needed for executing the functions by using the processor of the computer on the basis of a predetermined procedure. Also, the code may further include additional information, needed for executing the functions by using the processor of the computer, or a memory reference-related code corresponding to a location (an address) of an internal or external memory of the computer, which is to be referred to by a media.

Also, when the processor needs communication with a remote computer or server so as to execute the functions, the code may further include a communication-related code corresponding to a communication scheme needed for communication with the remote computer or server and information or a media to be transmitted or received in performing communication, by using a communication module of the computer.

The stored medium may denote a device-readable medium semi-permanently storing data, instead of a medium storing data for a short moment like a register, a cache, and a memory. In detail, examples of the stored medium may include read only memory (ROM), random access memory (RAM), CD-ROM, a magnetic tape, floppy disk, and an optical data storage device, but are not limited thereto. That is, the program may be stored in various recording mediums of various servers accessible by the computer or various recording mediums of the computer of a user. Also, the medium may be distributed to computer systems connected to one another over a network and may store a code readable by a computer in a distributed scheme.

The foregoing description of the present invention is for illustrative purposes, those with ordinary skill in the technical field of the present invention pertains in other specific forms without changing the technical idea or essential features of the present invention that may be modified to be able to understand. Therefore, the embodiments described above, exemplary in all respects and must understand that it is not limited. For example, each component may be distributed and carried out has been described as a monolithic and describes the components that are to be equally distributed in combined form, may be carried out.

According to the embodiments of the present invention, the NPC generating device and method may support a user so that the user adjusts a desired game environment, level of difficulty, and detailed skill level in real time, and thus, may provide various content.

Moreover, even when an environment is changed through content update, the NPC generating device and method may quickly adapt NPCs to a corresponding environment, and thus, may detect an unexpected adverse effect. Based on such a method, a manufacturer may reduce the content creating cost and the test cost, thereby increasing profits.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A device for generating a non-player character (NPC) capable of adjusting a skill level, the device comprising:
an NPC generator configured to generate an NPC having a skill level value adjusted based on a certain skill level adjustment parameter for each skill level factor;
an NPC pool storage configured to store the generated NPC; and
an NPC extractor configured to extract an NPC, corresponding to a skill level value input by a user, in the NPC pool storage and to provide the extracted NPC to content.

2. The device of claim 1, wherein the NPC generator comprises:
a simulation unit configured to receive a skill level adjustment parameter for adjusting a skill level value of the NPC, to set environment information about the content, and to generate a result state of an NPC simulated based on the set environment information about the content; and
an evolution learning unit configured to generate an NPC on the basis of a result state of the simulated NPC from the simulation unit and to store the generated NPC in the NPC pool storage.

3. The device of claim 2, wherein the skill level adjustment parameter comprises a first skill level adjustment parameter, which is a skill level corresponding to a physical factor of the user, and a second skill level adjustment parameter which corresponds to a content play capability of the user.

4. The device of claim 2, wherein the simulation unit receives at least one fighting NPC among an NPC which plays based on a rule, a self-replicated NPC, and an NPC based on a finite state machine (FSM) and performs simulation.

5. The device of claim 2, wherein
the NPC generator further comprises an NPC play database configured to collect NPC play data generated in a simulation process performed by the simulation unit, and
the NPC play data comprises at least one of an environment setting parameter, a skill level adjustment parameter, (current or next) state information about an NPC, action information about the NPC, and compensation information about the NPC.

6. The device of claim 5, wherein the NPC generator further comprises an environment adaptation unit configured to a previously learned NPC to the evolution learning unit.

7. The device of claim 6, wherein the environment adaptation unit receives NPC play data, play data of the user, and a first NPC previously learned and stored in the NPC pool storage, generates a second NPC through an environment adaptation process based on a certain learning algorithm, and provides the second NPC to the evolution learning unit or stores the second NPC in the NPC pool storage.

8. The device of claim 1, wherein the NPC extractor comprises:
a skill level analyzer configured to analyze a correlation between the skill level adjustment parameter and the NPC stored in the NPC pool storage and to generate a skill level analysis function on the basis of the correlation; and
a skill level adjuster configured to extract an NPC, corresponding to a skill level value input by the user, in the NPC pool storage on the basis of the skill level analysis function and to provide the extracted NPC to the content.

9. The device of claim 8, wherein the skill level adjuster extracts an NPC, having a skill level value input by the user and a skill level value within a predetermined range, in the NPC pool storage.

10. The device of claim 8, wherein, when an NPC having a skill level value input by the user and a skill level value within a predetermined range is not stored in the skill level adjuster, the skill level adjuster combines a plurality of NPCs on the basis of the skill level analysis function to generate an NPC having the skill level value within the predetermined range.

11. The device of claim 8, wherein, when the skill level adjuster receives an input, which fixes at least one skill level value of a plurality of skill level factors, from the user, the skill level adjuster determines a skill level value corresponding to the other skill level factor on the basis of the skill level analysis function.

12. A device for generating a non-player character (NPC) capable of adjusting a skill level, the device comprising:
a communication module configured to receive a skill level value input from a user and to provide the user with a non-player character (NPC) corresponding to the received skill level value;
a memory including a program for adjusting a skill level value of an NPC on the basis of a certain skill level adjustment parameter for each skill level factor and an NPC pool storage configured to store NPCs; and
a processor configured to execute the program stored in the memory,
wherein, by executing the program, the processor generates an NPC having a skill level value adjusted based on a certain skill level adjustment parameter for each skill level factor, extracts an NPC, corresponding to the input skill level value, in the NPC pool storage, and provides the extracted NPC to content.

13. A method of generating a non-player character (NPC) capable of adjusting a skill level, the method performed by a computer comprising:
generating an NPC having a skill level value adjusted based on a certain skill level adjustment parameter for each skill level factor;
storing the generated NPC in an NPC pool storage;
receiving a skill level value input from a user;
extracting an NPC, corresponding to the received skill level value, in the NPC pool storage; and
providing the extracted NPC to content.

14. The method of claim 13, wherein the generating of the NPC having the skill level value adjusted based on the certain skill level adjustment parameter comprises:
receiving a skill level adjustment parameter for adjusting a skill level value of the NPC to set environment information about the content;
generating a result state of an NPC simulated based on the set environment information about the content; and
generating an NPC on the basis of a result state of the NPC and at least one of a first NPC previously learned and stored and a second NPC generated through a learning process to store the generated NPC in the NPC pool storage.

15. The method of claim 14, wherein the generating of the NPC having the skill level value adjusted based on the certain skill level adjustment parameter comprises: receiving NPC play data generated in the simulation process, play data of the user, and a first NPC previously learned and stored in the NPC pool storage and generating a second NPC through a learning process based on a certain learning algorithm.

16. The method of claim 13, wherein the extracting of the NPC corresponding to the received skill level value in the NPC pool storage comprises:
analyzing a correlation between the skill level adjustment parameter and the NPC stored in the NPC pool storage to generate a skill level analysis function; and
extracting an NPC, corresponding to the skill level value input by the user, in the NPC pool storage on the basis of the skill level analysis function.

17. The method of claim 16, wherein the extracting of the NPC corresponding to the received skill level value in the NPC pool storage comprises extracting an NPC, having a skill level value input by the user and a skill level value within a predetermined range, in the NPC pool storage.

18. The method of claim 16, wherein the extracting of the NPC corresponding to the received skill level value in the NPC pool storage comprises, when an NPC having a skill level value input by the user and a skill level value within a predetermined range is not stored in the skill level adjuster, combining a plurality of NPCs on the basis of the skill level analysis function to generate an NPC having the skill level value within the predetermined range.

19. The method of claim 16, wherein the extracting of the NPC corresponding to the received skill level value in the NPC pool storage comprises, when an input of fixing at least one skill level value of a plurality of skill level factors is received from the user, determining a skill level value corresponding to the other skill level factor on the basis of the skill level analysis function.
